(19) United States
(12) Patent Application Publication
(10) Pub. No.: US 2012/0154546 A1
(43) Pub. Date: Jun. 21, 2012

(54) APPARATUS AND METHOD FOR CAPTURING STEREOGRAPHIC IMAGES

(75) Inventors: Yun-Ji Ban, Daejeon (KR); Hye-Sun Kim, Daejeon (KR); Ho-Wook Jang, Daejeon (KR); Myung-ha Kim, Daejeon (KR); Seung-Woo Nam, Daejeon (KR)

(73) Assignee: Electronics and Telecommunications Research Institute, Daejeon (KR)

(21) Appl. No.: 13/330,626

(22) Filed: Dec. 19, 2011

(30) Foreign Application Priority Data
Dec. 21, 2010 (KR) 10-2010-0131560

(51) Int. Cl. H04N 13/02

(52) U.S. Cl. 348/47; 348/E13.074

(57) ABSTRACT

Disclosed herein are an apparatus and method for capturing stereographic images. The apparatus includes two cameras, a screen unit, and a processing unit. The two cameras capture left and right images, respectively. The screen unit receives a matching region between the left and right images from a user. The processing unit corrects errors corresponding to the two cameras based on the matching region, and captures a stereographic image.

### CROSS REFERENCE TO RELATED APPLICATION

This application claims the benefit of Korean Patent Application No. 10-2010-0131560, filed Dec. 21, 2010, which is hereby incorporated by reference in its entirety into this application.

### BACKGROUND OF THE INVENTION

1. Technical Field

The present invention relates generally to an apparatus and method for capturing stereographic images and, more particularly, to an apparatus and method for capturing stereographic images using two cameras.

2. Description of the Related Art

A method of capturing stereographic images is a technique of capturing stereographic images using cameras so that users can naturally perceive the stereographic images, based on an analysis of the process by which humans sense stereographic images. The apparatus for capturing stereographic images uses two cameras as a human uses two eyes. In this case, there is a need for devices that fasten the two cameras. Furthermore, dizziness-free images can be acquired only when the pieces of information of the two cameras are accurately consistent with each other.

In general, the apparatus for capturing stereographic images includes two cameras, rigs corresponding to fastening devices, and a capturing device for checking captured images. The most important points to be considered when a stereographic image is captured are the removal of errors from the images acquired by the two cameras and the minimization of the possibility of causing dizziness. If the positions of the two cameras are fixed using the rigs, the vertical and horizontal errors in the images should be minimized and the optical characteristics of the two cameras should be matched with each other.

In the prior art, the vertical and horizontal errors in the two images, the distortion, and the differences in the characteristics of the cameras can be known by analyzing the two images, acquired by the two cameras, in real time using additional hardware. Here, the additional hardware is an expensive specialized device that can process two sheets of High-Definition (HD) images at the same time. Accordingly, there is a need for a method which may be easily used at places where stereographic image capturing is applied and which can process images in real time even using an ordinary inexpensive device.

In order to match the pieces of information of two cameras with each other, the camera calibration process is the most important thing. The calibration process enables the accurate positions of the two cameras to be determined, thereby overcoming errors that may occur while a stereoscopic image is captured.

In general, a preset pattern is used in the calibration process. Here, the most widely used type of pattern includes a checkerboard, and the type of pattern may vary depending on the calibration method. At the site of actual capturing, however, it is difficult to carry a large checkerboard, and it is inconvenient to stand the board up when setting the capturing settings. Accordingly, the checkerboard is rarely used. Furthermore, it is difficult to use the checkerboard because the capturing setting time takes too long.

### SUMMARY OF THE INVENTION

Accordingly, the present invention has been made keeping in mind the above problems occurring in the prior art, and an object of the present invention is to provide an apparatus and method for capturing stereographic images using two cameras.

In order to accomplish the above object, the present invention provides an apparatus for capturing stereographic images, the apparatus including two cameras for capturing left and right images, respectively; a screen unit for receiving a matching region between the left and right images from a user; and a processing unit for correcting errors corresponding to the two cameras based on the matching region, and capturing a stereographic image.

The processing unit may include an input unit for receiving the matching region; a point search unit for searching the matching region for a matching point; a determination unit for determining whether the matching point is correct using a preset determination procedure; a calibration unit for generating camera parameters by performing a camera calibration operation if, as a result of the determination, it is determined the matching point is correct; and a correction unit for correcting errors in positions of the two cameras based on the camera parameters.

The point search unit may search for the matching point by applying a matching algorithm to the matching region.

If, as a result of the determination, it is determined that the matching point is not correct, the left and right images may be enlarged and provided to the user using the screen unit, and a matching region selected by the user another time may be received.

The screen unit may correspond to a touch screen for providing the matching region so that the user can select the matching region.

The apparatus may further include a camera control unit for controlling positions of the two cameras.

The apparatus may further include an output unit for providing the stereographic image to the user.

In order to accomplish the above object, the present invention provides a method of capturing stereographic images using two cameras, the method including receiving left and right images from the two cameras; receiving a matching region between the left image and the right image from a user; and correcting errors, corresponding to the two cameras, based on the matching region, and capturing a stereographic image.

The capturing may include searching the matching region for a matching point; determining whether the matching point is correct using a preset determination procedure; if, as a result of the determination, it is determined that the matching point is correct, generating camera parameters by performing a camera calibration operation; and correcting errors in positions of the two cameras based on the camera parameters.

The searching may include searching for the matching point by applying a preset matching algorithm to the matching region.

The method may further include, if, as a result of the determination, it is determined that the matching point is not correct, enlarging the left image and the right image, and providing the enlarged images to the user; and receiving a matching region between the left image and the right image, which was selected by the user another time.

The receiving a matching region may include providing the left and right images to the user using a touch screen and receiving the matching region selected by the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 schematically shows the construction of an apparatus for capturing stereographic images according to an embodiment of the present invention;

FIG. 2 shows the construction of a processing unit according to an embodiment of the present invention;

FIG. 3 is a diagram showing an example in which a screen unit is used according to an embodiment of the present invention; and

FIG. 4 is a flowchart illustrating a method of capturing stereographic images according to an embodiment of the present invention.

### DESCRIPTION OF THE PREFERRED EMBODIMENTS

Reference now should be made to the drawings throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

An apparatus and method for capturing stereographic images according to embodiments of the present invention will be described in detail below with reference to the accompanying drawings.

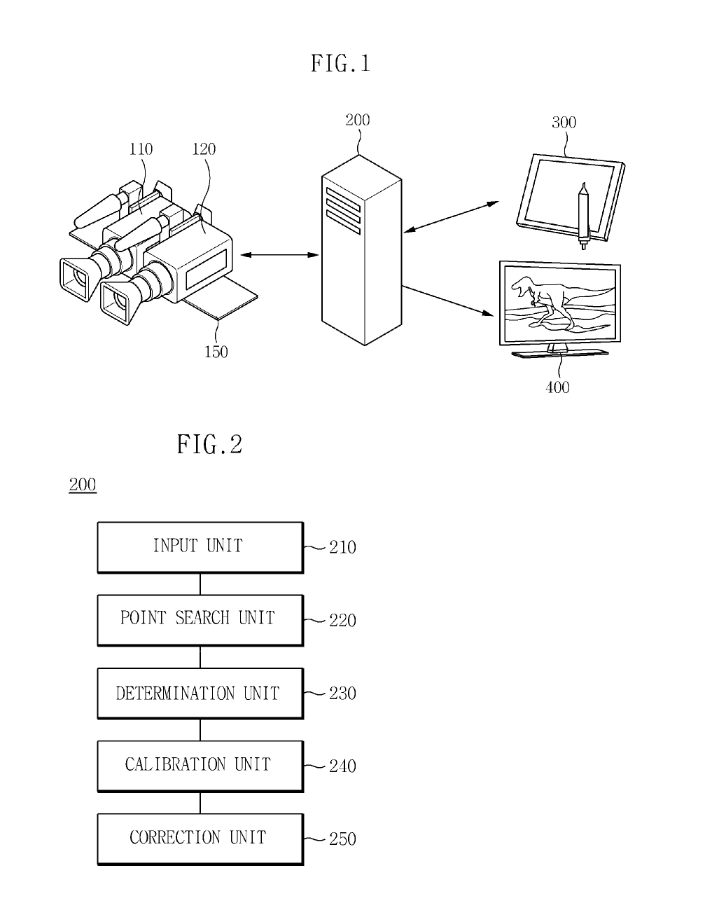

FIG. 1 schematically shows the construction of an apparatus for capturing stereographic images according to an embodiment of the present invention.

Referring to FIG. 1, the apparatus for capturing stereographic images includes two cameras 110 and 120, a camera control unit 150, a processing unit 200, a screen unit 300, and an output unit 400. Although the apparatus for capturing stereographic images according to the embodiment of the present invention are illustrated as including the two cameras 110 and 120, the camera control unit 150, and the screen unit 300 as described above, the two cameras, the camera control unit and the screen unit may be externally provided and operate in conjunction with the other components.

The two cameras 110 and 120 capture left and right images of a corresponding area, respectively.

The camera control unit 150 corresponds to rigs that control the positions of the two cameras 110 and 120.

The processing unit 200 captures a stereographic image by correcting the positions of the two cameras 110 and 120 and an error corresponding to the camera control unit 150 used to control the two cameras 110 and 120, based on a matching region corresponding to the left and right images received from the two cameras 110 and 120.

The screen unit 300 corresponds to a touch screen, and receives the matching region of the left and right images acquired by the two cameras 110 and 120 from a user. Next, the screen unit 300 transfers the selected matching region to the processing unit 200.

The screen unit 300 according to the embodiment of the present invention provides the function of enabling a user to freely enlarge or reduce an image. Accordingly, a user can easily select a matching region or matching pixels included in the matching region.

The output unit 400 provides a user with a stereographic image captured by the processing unit 200.

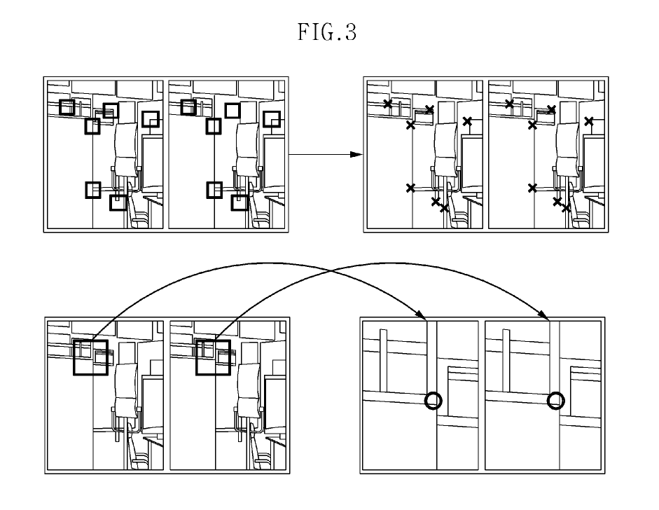

The processing unit 200 will now be described in detail with reference to FIG. 2.

FIG. 2 shows the construction of the processing unit 200 according to an embodiment of the present invention.

Referring to FIG. 2, the processing unit 200 includes an input unit 210, a point search unit 220, a determination unit 230, a calibration unit 240, and a correction unit 250.

The input unit 210 receives a matching region between a left image and a right image. Here, the input unit 210 manually receives a matching region between the two images via the screen unit 300.

The point search unit 220 searches the matching region for a matching point. Here, the point search unit 220 may search for the matching point by applying a matching algorithm to the matching region, but the present invention is not limited thereto.

When a matching point is searched for by automatically searching left and right images, real-time processing is difficult because both the left and right images should be analyzed. In contrast, when the matching algorithm is applied to the matching region according to an embodiment of the present invention, the matching algorithm is applied to an image corresponding to the matching region, not both the left image and the right image. Accordingly, the size of an image is reduced, and therefore real-time processing is possible.

The determination unit 230 determines whether the retrieved matching point is correct using a preset determination procedure.

The calibration unit 240 generates camera parameters by performing a camera calibration operation on the matching point. Here, the camera calibration operation is the process of generating camera parameters (i.e., a specific standard) by adjusting the matching point in accordance with the characteristics and properties of the two cameras 110 and 120.

Although the calibration unit 240 according to an embodiment of the present invention has been described as generating camera parameters using the camera calibration operation, it may generate camera parameters using rig convergence, an Inter Ocular Distance (IOD) between cameras, and zoom control.

The correction unit 250 corrects errors in the positions of the two cameras 110 and 120 and control information related to the control of the camera control unit 150 based on the camera parameters.

The screen unit 300 will now be described in detail with reference to FIG. 3.

FIG. 3 is a diagram showing an example in which the screen unit 300 is used according to an embodiment of the present invention.

Referring to FIG. 3, the screen unit 300 provides a left image and a right image to a user, and receives at least one matching region from the user.

Thereafter, the processing unit 200 searches the matching region for a matching point, and may output a result on the screen unit 300. If the output result is not correct or erroneous, the user may enlarge the matching region and manually input the matching point using the screen unit 300.

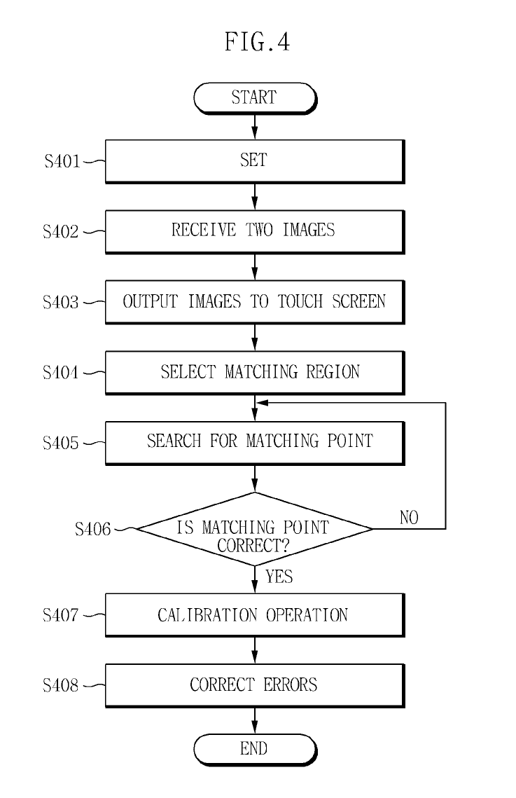

A method of capturing stereographic images will be described in detail below with reference to FIG. 4.

FIG. 4 is a flowchart illustrating the method of capturing stereographic images according to an embodiment of the present invention.

First, the apparatus for capturing stereographic images according to the embodiment of the present invention operates in conjunction with the two cameras 110 and 120, the camera control unit 150, and the screen unit 300.

Referring to FIG. 4, the apparatus for capturing stereographic images sets the two cameras 110 and 120, the camera control unit 150 and the screen unit 300 at a place where a stereographic image will be captured at step S401.

The apparatus for capturing stereographic images receives a left image and a right image from the two cameras 110 and 120 at step S402.

The apparatus for capturing stereographic images outputs the left image and the right image to a user using the screen unit 300 at step S403. Here, the screen unit 300 corresponds to a touch screen.

The apparatus for capturing stereographic images receives a matching region, selected by the user, from the screen unit 300 at step S404. Here, the matching region corresponds to a region where the left image and the right image acquired by the two cameras 110 and 120 have been matched to each other.

The apparatus for capturing stereographic images searches the matching region for a matching point at step S405. Here, the apparatus for capturing stereographic images may search for the matching point by applying a specific matching algorithm to the matching region.

The apparatus for capturing stereographic images determines whether the retrieved matching point is correct using a preset determination procedure at step S406.

If as a result of the determination, it is determined that the matching point is not correct, the apparatus for capturing stereographic images enlarges the left and right images and provides the enlarged images to the user using the screen unit 300. Here, the screen unit 300 provides the user with a matching region or matching pixels which are more detailed than the matching region. Accordingly, the user selects the matching region again. This process is repeated until a correct matching point is retrieved.

If as a result of the determination, it is determined that the matching point is correct, the apparatus for capturing stereographic images generates camera parameters by performing a camera calibration operation on the matching point at step S407.

The apparatus for capturing stereographic images corrects errors in the positions of the two cameras 110 and 120 and control information related to the control of the camera control unit 150 based on the camera parameters and then captures a stereographic image at step S408.

The apparatus for capturing stereographic images according to the embodiment of the present invention calculates the accurate positions of cameras by performing calibration on the cameras in real time, and minimizes vertical and horizontal errors by correcting errors in the rigs. Accordingly, a high-quality stereographic image can be captured. Here, the apparatus for capturing stereographic images can easily receive input from a user using a touch screen, and set the camera settings corresponding to the input in real time. Accordingly, there is a high possibility that the apparatus of the present invention will be used in a capturing place.

Furthermore, if calibration is automatically performed because a subject is continuously changed in a place where a pattern is not used, there are problems in that a lot of errors are generated and the time taken to correct the errors is long. However, the present invention can reduce the generation of the errors and perform calculations accurately. Accordingly, a high-quality image can be acquired.

As described above, according to the embodiments of the present invention, the apparatus and method for capturing stereographic images can accurately perform calibration in real time using common pieces of equipment (e.g., cameras, rigs, and a touch screen).

Furthermore, according to the embodiments of the present invention, the apparatus and method for capturing stereographic images can obtain high-quality stereographic images using the properties of cameras, rigs, and a touch screen.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for capturing stereographic images, the apparatus comprising:
two cameras for capturing left and right images, respectively;
a screen unit for receiving a matching region between the left and right images from a user; and
a processing unit for correcting errors corresponding to the two cameras based on the matching region, and capturing a stereographic image.

2. The apparatus as set forth in claim 1, wherein the processing unit comprises:
an input unit for receiving the matching region;
a point search unit for searching the matching region for a matching point;
a determination unit for determining whether the matching point is correct using a preset determination procedure;
a calibration unit for generating camera parameters by performing a camera calibration operation _{if} as a result of the determination, it is determined the matching point is correct; and
a correction unit for correcting errors in positions of the two cameras based on the camera parameters.

3. The apparatus as set forth in claim 2, wherein the point search unit searches for the matching point by applying a matching algorithm to the matching region.

4. The apparatus as set forth in claim 2, wherein if, as a result of the determination, it is determined that the matching point is not correct, the left and right images are enlarged and provided to the user using the screen unit, and a matching region selected by the user another time is received.

5. The apparatus as set forth in claim 1, wherein the screen unit corresponds to a touch screen for providing the matching region so that the user can select the matching region.

6. The apparatus as set forth in claim 1, further comprising a camera control unit for controlling positions of the two cameras.

7. The apparatus as set forth in claim 1, further comprising an output unit for providing the stereographic image to the user.

8. A method of capturing stereographic images using two cameras, the method comprising:
receiving left and right images from the two cameras;
receiving a matching region between the left and right images from a user; and
correcting errors, corresponding to the two cameras, based on the matching region, and capturing a stereographic image.

9. The method as set forth in claim 8, wherein the capturing comprises:
searching the matching region for a matching point;
determining whether the matching point is correct using a preset determination procedure;
if, as a result of the determination, it is determined that the matching point is correct, generating camera parameters by performing a camera calibration operation; and
correcting errors in positions of the two cameras based on the camera parameters.

10. The method as set forth in claim 9, wherein the searching comprises searching for the matching point by applying a presetmatching algorithm to the matching region.

11. The method as set forth in claim 9, further comprising, if, as a result of the determination, it is determined that the matching point is not correct:
enlarging the left image and the right image, and providing the enlarged images to the user; and
receiving a matching region between the left image and the right image, which was selected by the user another time.

12. The method as set forth in claim 8, wherein the receiving a matching region comprises providing the left and right images to the user using a touch screen and receiving the matching region selected by the user.
